(19) United States
(12) Patent Application Publication
(10) Pub. No.: US 2025/0264121 A1
(43) Pub. Date: Aug. 21, 2025

(54) Magnet Fastener

(71) Applicant: Illinois Tool Works Inc., Glenview, IL (US)

(72) Inventors: Logan Scott Irvine, Chippewa Falls, WI (US); James S. Tisol, JR., Chippewa Falls, WI (US)

(21) Appl. No.: 19/024,978

(22) Filed: Jan. 16, 2025

Related U.S. Application Data
(60) Provisional application No. 63/556,068, filed on Feb. 21, 2024.

(51) Int. Cl. F16B 2/20; B60R 13/02

(52) U.S. Cl. CPC F16B 2/20; B60R 13/0206; F16B 2200/83

(57) ABSTRACT

Disclosed is a magnet fastener assembly for attaching a first component to a second component. The magnet fastener assembly includes a pin, a magnet, a magnet retainer, and a clip feature. The pin has a head and a shank. The magnet retainer includes a basket structure and a post. The basket structure is configured to flex and accommodate the magnet. The post is configured to receive a shank of a pin. The clip feature coupled to the magnet retainer via a base and configured to couple to the first component.

### RELATED APPLICATION

The present application claims priority to U.S. Provisional Patent Application No. 63/556,068, filed Feb. 21, 2024, and entitled “Magnet Fastener,” which is hereby incorporated by reference in its entirety.

### BACKGROUND

Automotive components require fastening techniques that are simple to manufacture and assemble. Further, fastening techniques should above all be reliable and efficient. Fastening clips are particularly useful to secure automotive components; for example, to secure headliners, interior panels, and the like to roofs, door structures, and other automotive components.

An automobile headliner is typically made of cloth, foam or other suitable material and generally includes a substrate layer. Various interior automobile mechanisms can be used to retain the headliner in position against the automobile roof, such as fastener clips. The fastener clip can be secured to the component (e.g., the automobile headliner) by an adhesive (e.g., glue), clips, doghouses, etc., and can be attached to the underlying roof structure by one of several known arrangements. In some examples, a magnetic fastener clip is used to secure the headliner to the mating roof structure by way of the magnet. For example, commonly-owned U.S. Pat. No. 7,306,190 discloses a fastener for securing automobile headliners to automobile roofs via a magnet assembly.

While magnetic fasteners of the type generally described have facilitated installation of automobile headliners, there is a continuing need for improved structures and arrangements for such magnetic fasteners.

### SUMMARY

The present disclosure relates generally to a magnet fastener and magnet fastener assembly, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a perspective assembly view of an example magnet fastener assembly in accordance with an aspect of this disclosure.

FIG. 2a illustrates a top perspective view of the magnet fastener used in the magnet fastener assembly of FIG. 1.

FIG. 2b illustrates a bottom perspective view of the magnet fastener.

FIGS. 2c through 2f illustrate, respectively, first, second, third, and fourth side views of the magnet fastener.

FIGS. 2g and 2h illustrate, respectively, top and bottom plan views of the magnet fastener.

FIG. 3 illustrates a perspective view of an example magnet fastener assembly integrated with an automotive component in accordance with another aspect of this disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a magnet fastener assembly configured to join a first component to a second component. In one example, a magnet fastener for attaching a first component to a second component via a magnet comprises: a magnet retainer, wherein the magnet retainer includes a basket structure and a post, wherein the basket structure is configured to flex and accommodate the magnet, and wherein the post is configured to receive a shank of a pin; and a clip feature coupled to the magnet retainer via a base and configured to couple to the first component.

In another example, a magnet fastener assembly for attaching a first component to a second component comprises: a pin having a head and a shank; a magnet; a magnet retainer, wherein the magnet retainer includes a basket structure and a post, wherein the basket structure is configured to flex and accommodate the magnet, and wherein the post is configured to receive a shank of a pin; and a clip feature coupled to the magnet retainer via a base and configured to couple to the first component.

In yet another example, a magnet fastener assembly for attaching to a second component comprises: a magnet retainer that is integrated with a first component, wherein the magnet retainer includes a basket structure and a post, wherein the basket structure is configured to flex and accommodate the magnet, and wherein the post is configured to receive a shank of a pin; and a clip feature coupled to the magnet retainer via a base and configured to couple to the first component.

In some examples, the post is configured to engage the magnet via a central opening thereof.

In some examples, the basket structure is substantially concave and faces away from the base.

In some examples, the magnet fastener comprises a central aperture passing there through.

In some examples, the post and the basket structure are each generally circular and concentric relative to one another and to the central aperture.

In some examples, the basket structure comprises a plurality of wall segments and a plurality of gaps.

In some examples, each of the plurality of wall segments is an elongated, protruding curved structure that is connected at one end to the base and extends radially outward from a central axis of the magnet fastener.

In some examples, the basket structure is configured to enable the magnet to articulate about the post.

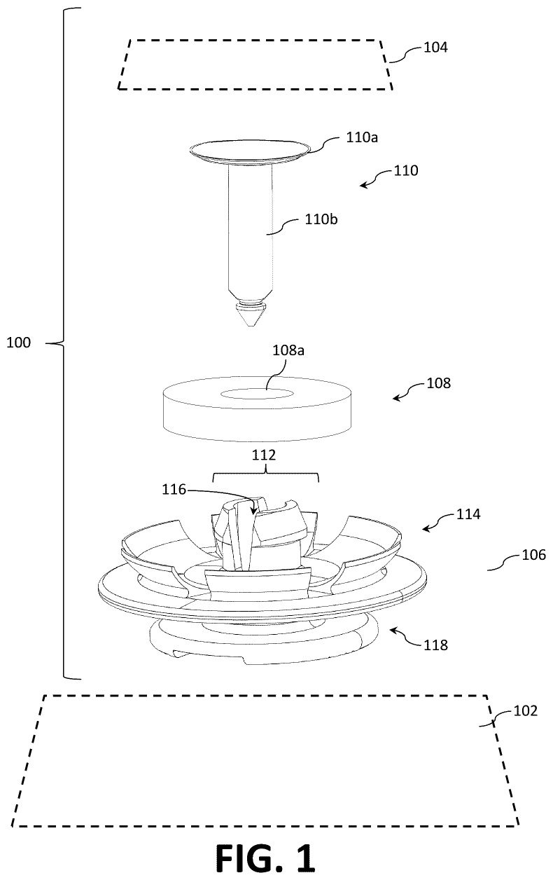

FIG. 1 illustrates a perspective assembly view of an example magnet fastener assembly 100 in accordance with an aspect of this disclosure. The illustrated magnet fastener assembly 100 is configured to form a blind connection between the first component 102 and the second component 104. While only a single magnet fastener assembly 100 illustrated in the example, it should be appreciated that multiple fastening assemblies 100 may be used to couple a first component 102 to a second component 104, depending on the number of fastener points needed between the first and second components 102, 104. For example, larger components and panels typically require multiple fastening points.

The first component 102 and the second component 104 may be, for example, automotive components. Depending on the application, the first component 102 and the second component 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 102 include, without limitation, headliners, door trim panels, moldings, trim pieces, and other substrates. The second component 104 may be, for example, a structural component of a vehicle, such as the roof, doors, pillars (e.g., an A-pillar, B-pillar, C-pillar, etc.), dashboard components (e.g., a cross member, bracket, frame, etc.), seat frames, center consoles, fenders, sheet metal framework, or the like. In an example, the first component 102 is non-magnetic (e.g. non-ferrous) and the second component 104 is magnetic (e.g., ferrous).

The magnet fastener assembly 100 shown in the exemplary embodiment of FIG. 1 is suitable for use as a blind fastener to attach an automobile headliner to the interior side of a roof of a vehicle, for example. While the illustrated magnet fastener assembly 100 is used to form a blind connection between a vehicle headliner and the roof of a vehicle, it should be understood that the principles of the present disclosure can be used in fasteners of other types and for purposes other than fastening automobile components.

The magnet fastener assembly 100 generally comprises a magnet fastener 106, a magnet 108 (illustrated as an annular magnet), and a pin 110. The pin 110 comprises a head portion 110a and a shank 110b. As illustrated, the magnet 108 is connected to the magnet fastener 106 using a combination of a post 112 and the pin 110. To that end, the shank 110b is sized and shaped to pass through an opening 108a form in the magnet 108 to engage the magnet fastener 106 via a central aperture 116. As will be discussed, the magnet fastener 106 can connect to the magnet 108 for connection to another component, while allowing the magnet 108 to tilt relative to the post 112 of the magnet fastener 106.

The magnet fastener assembly 100 is attached to second component 104 magnetically via the magnet 108 coupled thereto at the magnet retainer 114 and attached to the first component 102 via the clip feature 118 using, for example and depending on the material type, adhesive (e.g., glue), a mechanical feature (e.g., clips, a doghouse interface, etc.), or even a second magnet. While the post 112 is configured to secure the magnet 108 to the magnet fastener 106, the strength of the magnet 108 (when connected to the second component 104) may exceed the retention force of the post 112 alone. To address this, the pin 110 increases the retention force of the magnet 108 relative to the magnet fastener 106 to secure the magnet 108 in the magnet retainer 114.

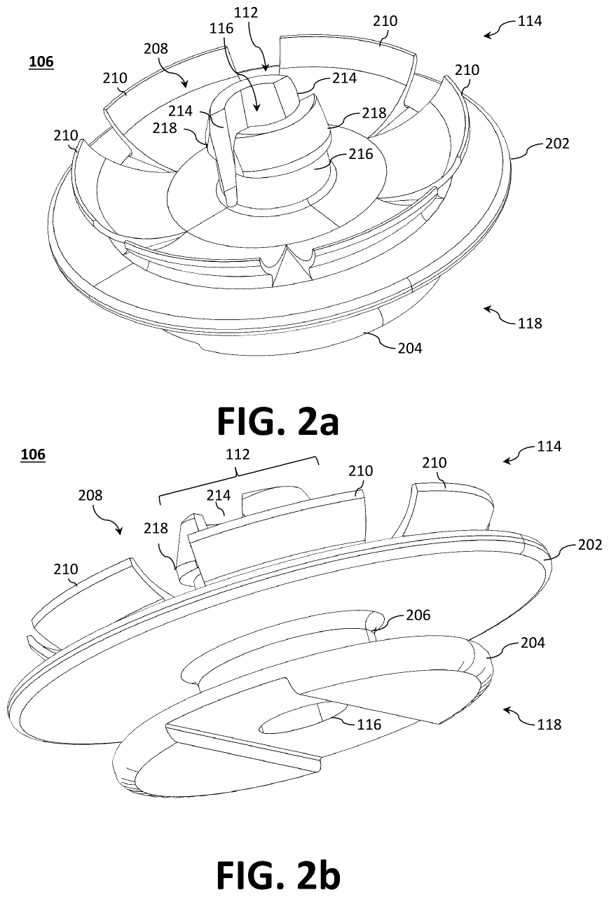

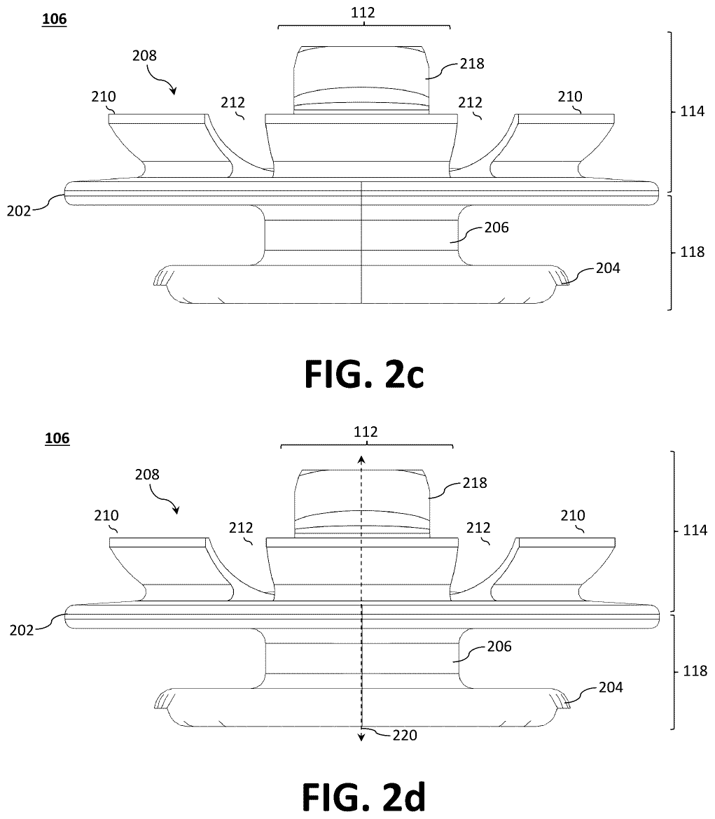

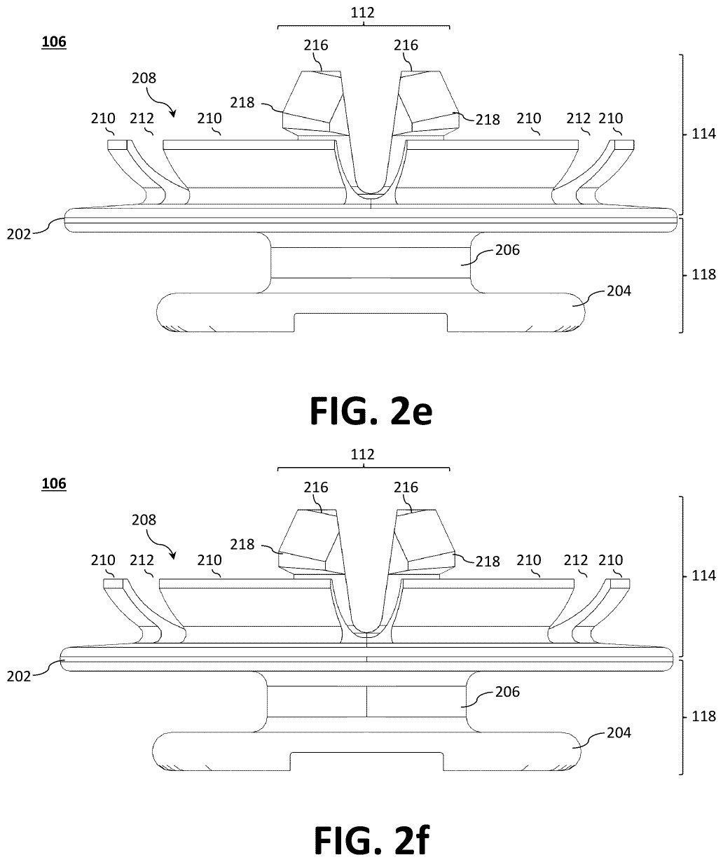

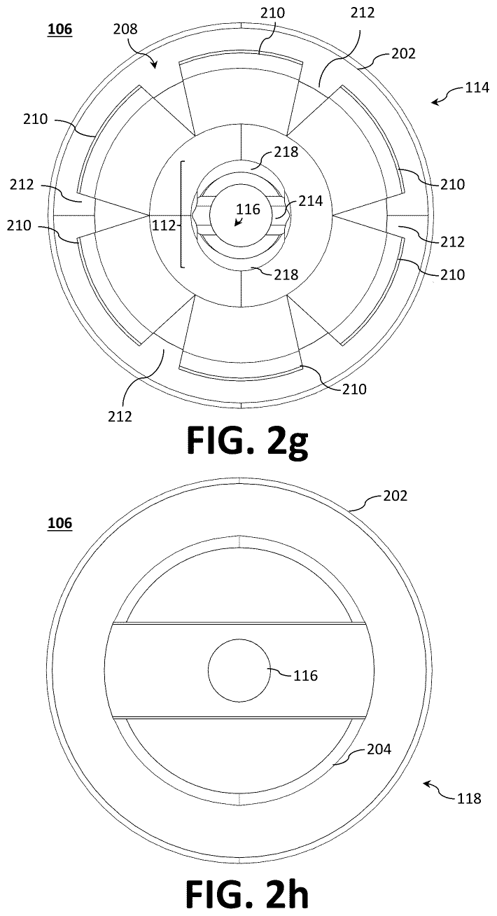

FIGS. 2a and 2b illustrate, respectively, top and bottom perspective views of the magnet fastener 106 used in the magnet fastener assembly 100. FIGS. 2c through 2f illustrate, respectively, first, second, third, and fourth side views of the magnet fastener 106, while FIGS. 2g and 2h illustrate, respectively, top and bottom plan views of the magnet fastener 106. The illustrated magnet fastener 106 generally comprises the magnet retainer 114 joined to a clip feature 118 via a base 202. The magnet retainer 114, the clip feature 118, and the base 202 can be a unitary structure (e.g., a single monolithic body). The base 202 is substantially circular, although other shapes and configurations also can be used. The magnet fastener 106 defines the central aperture 116 that passes between the magnet retainer 114 and the clip feature 118 and is configured to receive a shank 110b of the pin 110. The clip feature 118 generally comprises plate 204 spaced from the base 202 via a stem 206. The plate 204 is attached to the first component 102.

The magnet fastener 106 can be made from various materials, including synthetic or semi-synthetic polymers (e.g., plastics, such as acrylonitrile butadiene styrene (ABS) and polyvinyl chloride (PVC), etc.), composite materials (e.g., fiber glass), metal (or a metal alloy), or a combination thereof. In one example, the magnet fastener 106 can be fabricated via mold tooling and a plastic-injection molding process. In another example, the magnet fastener 106 can be a printed thermoplastic material component that can be printed with great accuracy and with numerous details, which is particularly advantageous, for example, in creating components requiring complex and/or precise features.

Additive manufacturing techniques obviate the need for mold tooling typically associated with plastic injection molding, thereby lowering up-front manufacturing costs, which is particularly advantageous in low-volume productions. In some examples, components of the fastener assembly 100 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

The magnet retainer 114 generally comprises the post 112 and a basket structure 208. The illustrated basket structure 208 is substantially concave and faces away from the base 202. In the illustrated example, the post 112 and the basket structure 208 are each generally circular and concentric relative to one another and to the central aperture 116.

The basket structure 208 comprises a plurality of a plurality of wall segments 210 and a plurality of gaps 212. Each of the plurality of wall segments 210 can be an elongated, protruding curved structure connected at one end to the base 202 and extending radially outward from the central axis 220 of the magnet fastener 106. In the illustrated example, adjacent wall segments 210 are separated by a gap 212, creating a segmented, flexible basket structure 208 that allows for compression and deformation. While six wall segments 210 and six gaps 212 are shown, additional or fewer wall segments 210 and gaps 212 may be employed based on, for example, needs and requirements around assembly and performance. Thus, the number of gaps 212 and wall segments 210 can vary depending on application and/or the size of the basket structure 208.

The gaps 212 provide flexibility and enable the basket structure 208 to cup and to adapt to varying shapes and sizes of the magnet 108. The cupping afforded by the concave shape of the basket structure 208 also enables the magnet 108 to articulate about the post 112 within a cavity of the basket structure 208 during assembly with the second component 104. For example, the second component 104 may not align perfectly with the magnet 108 during assembly; however, to address this, the magnet 108 can articulate (e.g., tilt, pivot, etc.) about the post 112 to effectively conform to the surface of the second component 104. In addition, the flexible nature of the basket structure 208 mitigates vibrations and thus mitigates buzz, squeak and rattle (BSR). Accordingly, the described basket structure 208 obviates the need for a seal or other dampening component such that the magnet 108 can be coupled directly to the magnet fastener 106. Omitting the seal and other dampening components reduces cost, complexity, and weight.

The post 112 is defined substantially centrally in basket structure 208 and projects outwardly from the basket structure 208 relative to base 202. During assembly, the magnet 108 slides over the post 112 and into the cavity of the basket structure 208. The gaps 212 enable the wall segments 210 to flex and accommodate the magnet 108.

The post 112 is hollow (i.e., to provide the central aperture 116) and includes one or more substantially axial slots 214 on diametrically opposite sides to thereby separate the post 112 into opposed legs 216. As illustrated, a distal portion of each leg 216 defines an outward protuberance 218 that collectively forms the widest portion of post 112. The protuberances 218 in the exemplary embodiment are comprised of single segments each spanning the outer surface of legs 216, respectively. However, it should be understood that protuberances 218 can be narrower than the full width of legs 216 or can be comprised of two or more segments on each leg 216. From protuberances 218 the distal portion of post 112 angles or tapers radially inwardly.

The pin 110 includes a substantially cylindrical shank 110b, as seen most clearly in FIG. 1. In the manufactured condition of magnet fastener 106, during the molding or other formation of magnet fastener 106, pin 110 is aligned with and connected within the axial opening 116 through hollow post 112. Pin 110 is connected within basket structure 208 by one or more engagement features. Accordingly, as manufactured, magnet fastener 106 is a single, integral unit.

The magnet fastener assembly 100 is secured to a headliner or the like by placing the plate 204 against the first component 102 (e.g., a substrate of the headliner) and attaching it with glue or the like. The glue or other adhesive can pass through openings or channels in plate 204 to adhere and physically lock the plate 204 against the first component 102. In a known manner, foam can be applied over the headliner material or substrate and around the plate 204.

The magnet 108 is illustrated as an annular or doughnut-like magnetic body of a size to fit within the basket structure 208. The magnet 108 has a central opening 108a, which is retained relative to the post 112 and basket structure 208 via protuberances 218. The magnet 108 is attached to magnet fastener 106 by inserting a distal end of post 112 into central opening 108a and pushing the magnet 108 along post 112 and over protuberances 218.

The tapered configuration of post 112 between the protuberances 218 and the distal end assists in locating the magnet 108 on the post 112, and in aligning the magnet 108 for proper insertion on the post 112. The tapered configuration further assists in deflecting the legs 216 as necessary for passing the magnet 108 fully and completely onto post 112. Since the post 112 is hollow, with slots 214 on opposite sides thereof, individual legs 216 are deflected inwardly so that the protuberances 218 will pass through the opening 108a. Upon the protuberances 218 passing fully through the opening 108a, legs 216 rebound outwardly such that protuberances 218 overlap adjacent the opening 108a.

To lock the magnet 108 in proper position on post 112, the pin 110 is pushed into distal regions of the post 112. In the as-manufactured condition, pin 110 is aligned with the axial opening 116 extending through hollow post 112. The pin 110 can be pushed by hand or mechanically to position the pin 110 into the post 112 to a blocking position between and adjacent legs 216 whereby legs 216 are restricted from inward deflection. Mechanical pushing the pin 110 to advance the pin 110 into the post 112 can be accomplished with a pusher that is forced against the pin 110 and advanced through the aperture 116 before the plate 204 is connected to the first component 102. With pin 110 inserted into post 112, legs 216 cannot be deflected inwardly and are retained in the outward position with protuberances 218. Accordingly, the magnet 108 is locked in position on post 112.

The magnet 108 can be fitted on post 112 somewhat loosely. Accordingly, magnet 108 can tilt on post 112 in any direction, thereby allowing magnet 108 to align for substantially flush engagement against the second component 104 for a firm connection of magnet fastener assembly 100. Further, during installation or use magnet 108 can tilt slightly relative to each other to accommodate pushing force exerted there against without fracturing.

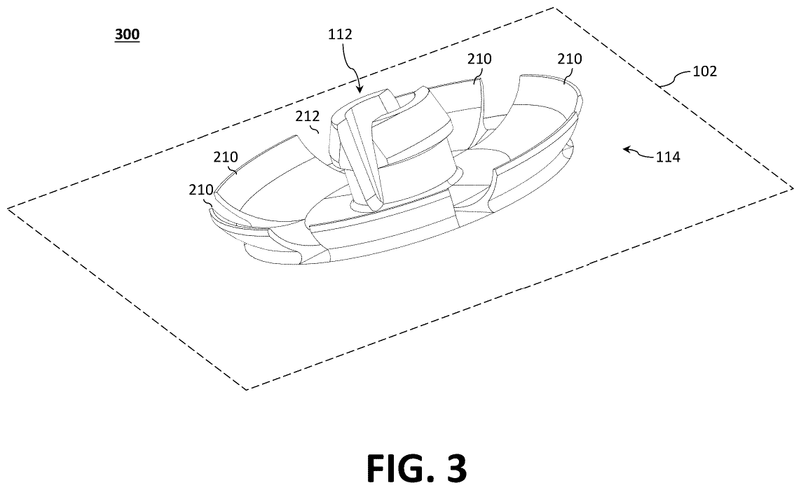

FIG. 3 illustrates a perspective view of an example integrated magnet fastener assembly 300 (e.g., integrated with the first component 102) in accordance with another aspect of this disclosure. While the magnet fastener 106 has been described as a separate component that is attached to the first component 102, the magnet fastener 106 (or a portion thereof) may instead be integrated with the first component 102, for example, as part of an additive manufacturing or plastic-injection molding process. In this example, the need for the clip feature 118 and base 202 would be obviated. By way of illustration, with reference to FIG. 3, the first component 102 can be fabricated with an integrated post 112 and integrated basket structure 208 to form an integrated magnet fastener assembly 300.

The above-cited patents and patent publications are hereby incorporated by reference in their entirety. While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A magnet fastener for attaching a first component to a second component via a magnet, the magnet fastener comprising:
a magnet retainer, wherein the magnet retainer includes a basket structure and a post,
wherein the basket structure is configured to flex and accommodate the magnet, and
wherein the post is configured to receive a shank of a pin; and
a clip feature coupled to the magnet retainer via a base and configured to couple to the first component.

2. The magnet fastener of claim 1, wherein the post is configured to engage the magnet via a central opening thereof.

3. The magnet fastener of claim 1, wherein the basket structure is substantially concave and faces away from the base.

4. The magnet fastener of claim 1, wherein the magnet fastener comprises a central aperture passing there through.

5. The magnet fastener of claim 4, wherein the post and the basket structure are each generally circular and concentric relative to one another and to the central aperture.

6. The magnet fastener of claim 1, wherein the basket structure comprises a plurality of wall segments and a plurality of gaps.

7. The magnet fastener of claim 6, wherein each of the plurality of wall segments is an elongated, protruding curved structure that is connected at one end to the base and extends radially outward from a central axis of the magnet fastener.

8. The magnet fastener of claim 1, wherein the basket structure is configured to enable the magnet to articulate about the post.

9. A magnet fastener assembly for attaching a first component to a second component, the magnet fastener assembly comprising:
a pin having a head and a shank;
a magnet;
a magnet retainer, wherein the magnet retainer includes a basket structure and a post,
wherein the basket structure is configured to flex and accommodate the magnet, and
wherein the post is configured to receive a shank of a pin; and
a clip feature coupled to the magnet retainer via a base and configured to couple to the first component.

10. The magnet fastener assembly of claim 9, wherein the post is configured to engage the magnet via a central opening thereof.

11. The magnet fastener assembly of claim 9, wherein the basket structure is substantially concave and faces away from the base.

12. The magnet fastener assembly of claim 9, wherein the magnet fastener comprises a central aperture passing there through.

13. The magnet fastener assembly of claim 12, wherein the post and the basket structure are each generally circular and concentric relative to one another and to the central aperture.

14. The magnet fastener assembly of claim 9, wherein the basket structure comprises a plurality of wall segments and a plurality of gaps.

15. The magnet fastener assembly of claim 14, wherein each of the plurality of wall segments is an elongated, protruding curved structure that is connected at one end to the base and extends radially outward from a central axis of the magnet fastener.

16. The magnet fastener assembly of claim 9, wherein the basket structure is configured to enable the magnet to articulate about the post.

17. A magnet fastener assembly for attaching to a second component, the magnet fastener assembly comprising:
a magnet retainer that is integrated with a first component, wherein the magnet retainer includes a basket structure and a post,
wherein the basket structure is configured to flex and accommodate the magnet, and
wherein the post is configured to receive a shank of a pin; and
a clip feature coupled to the magnet retainer via a base and configured to couple to the first component.

18. The magnet fastener assembly of claim 17, wherein the basket structure is substantially concave and faces away from the base.

19. The magnet fastener assembly of claim 17, wherein the basket structure comprises a plurality of wall segments and a plurality of gaps.

20. The magnet fastener assembly of claim 19, wherein each of the plurality of wall segments is an elongated, protruding curved structure that is connected at one end to the base and extends radially outward from a central axis of the magnet fastener.
